(19) United States
(12) Patent Application Publication
(10) Pub. No.: US 2007/0045338 A1
(43) Pub. Date: Mar. 1, 2007

(54) Food dispensing and distributing apparatus including sauce holder, and method of using

(76) Inventors: Toby M. Butler, Rochester, NY (US); Jeanine N. Sikora, Buffalo, NY (US)

Correspondence Address: Shlesinger & Fitzsimmons;Suite 1323, 183 East Main Street, Rochester, NY, 14604, US

(21) Appl. No.: 11/214,807

(22) Filed: Aug. 29, 2005

(51) Int. Cl. B05B 11/00

(52) U.S. Cl. 222/78

(57) ABSTRACT

A sauce holder on the front of a food dispensing/distribution apparatus, such as a French fry box, includes front and side walls that are collapsed until use. To use the holder, the user unfolds it, such as by pulling on the front wall, and inserts a sauce container. The container can be a plastic container with a seal on one end that the user can remove to access the sauce within. A window can be formed by including a removable portion of the front holder wall, which window can provide visual access to the side of the container for a sauce level check. The removable portion can include indicia, such as advertising, coupons, contests, and other promotional printing.

### CROSS-REFERENCE TO RELATED APPLICATIONS

This application is related to U.S. Design Pat. Application No. 29/199,570, filed 18 Feb. 2004, now U.S. Design Pat. D______, issued on ______ 2005 the disclosure of which is incorporated by reference.

### BACKGROUND AND SUMMARY

Fast food restaurants use millions of cardboard boxes every day to distribute French fries, onion rings, chicken nuggets and the like, and other foods typically eaten with hands rather than with utensils. Many of these foods can be eaten with sauces, such as catsup, honey, barbeque sauce, and the like. However, the sauces are typically distributed in flexible plastic packets or dispensed into small paper cups for consumption. This can be particularly problematic when one has purchased the food at a drive-through window or other form of take-out since there is no easy way to access the sauces. Thus, there is a need for a way for users of sauces to conveniently, easily, and safely access and use such sauces.

Embodiments include an improved food dispensing and distributing apparatus, such as a “French fry box,” that includes a compartment to hold ketchup or other sauces users might apply to food distributed in the apparatus. As with current boxes, embodiments are preferably made of paperboard and can be shipped in a collapsed state. While much of the box of embodiments is similar to current boxes, the sauce holder can be unfolded and used to hold sauce. While embodiments allow use of existing sauce packets, a new sauce container is offered in embodiments. The container is preferably rigid and has an opening at one end sealed with, for example, the same sort of material as is found on coffee half and half containers. With the improved French fry box and the preferred sauce container, consumers now have an easy and convenient way to use sauce with their fast food.

### BRIEF DESCRIPTION OF THE DRAWINGS

FIG. 1 is a front schematic elevational view of embodiments.

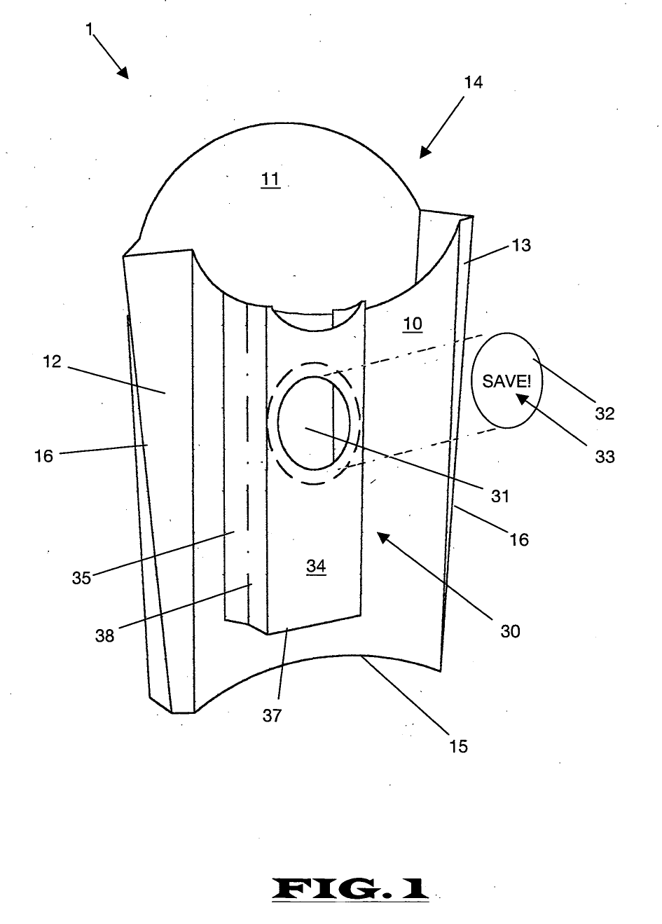

FIG. 2 is a schematic view of embodiments from the left with the sauce holder collapsed.

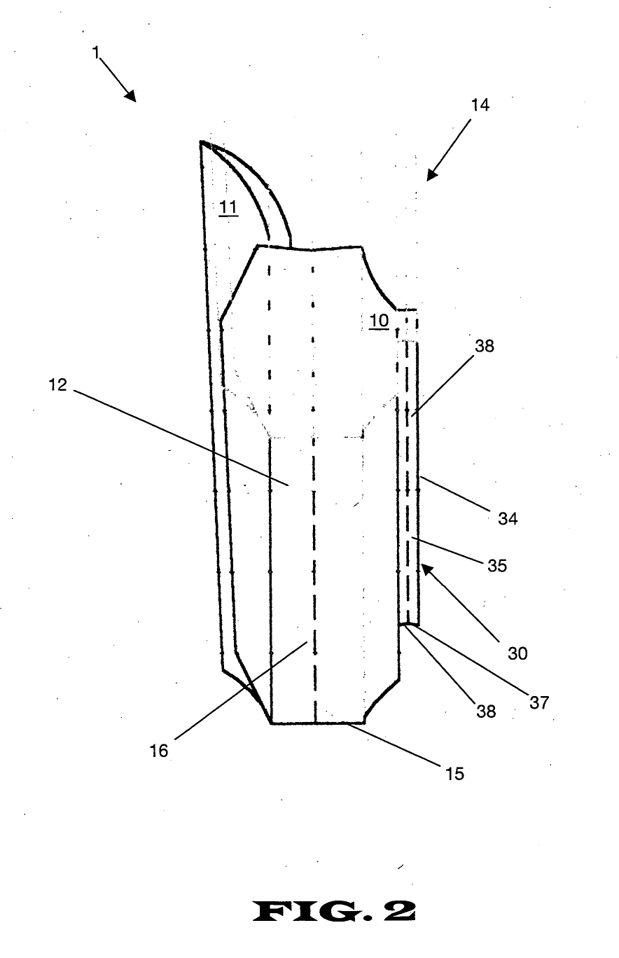

FIG. 3 is a schematic view of embodiments from the left with the sauce holder unfolded.

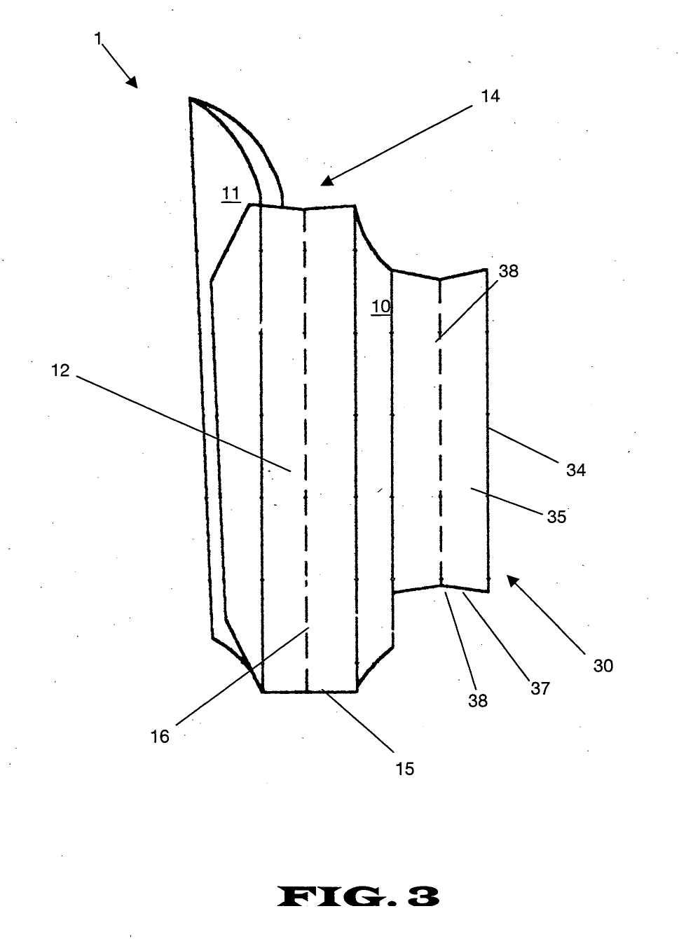

FIG. 4 is a schematic view of embodiments from the top with the sauce holder collapsed.

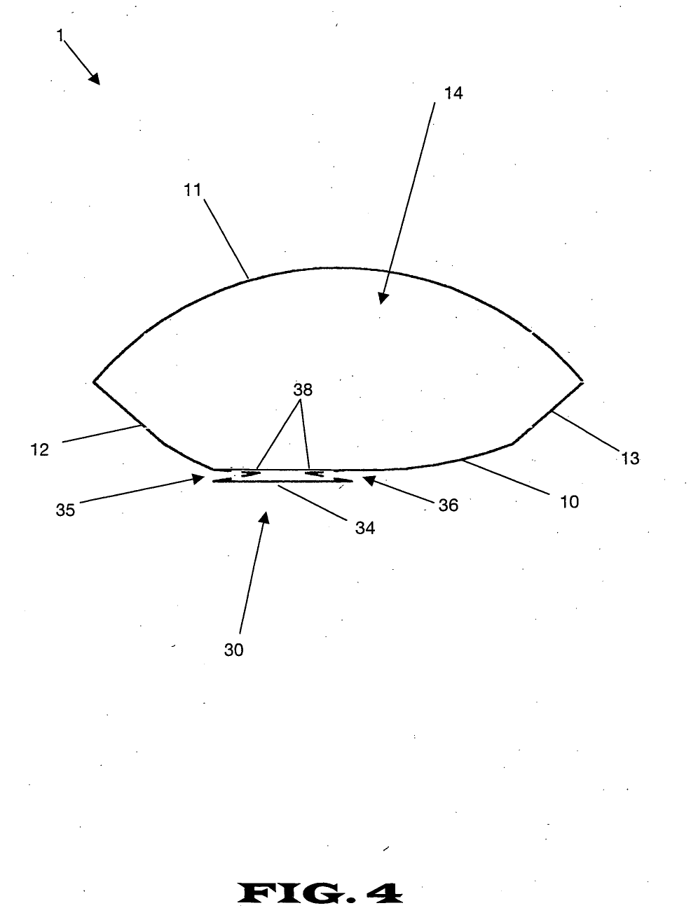

FIG. 5 is a schematic view of embodiments from the top with the sauce holder unfolded.

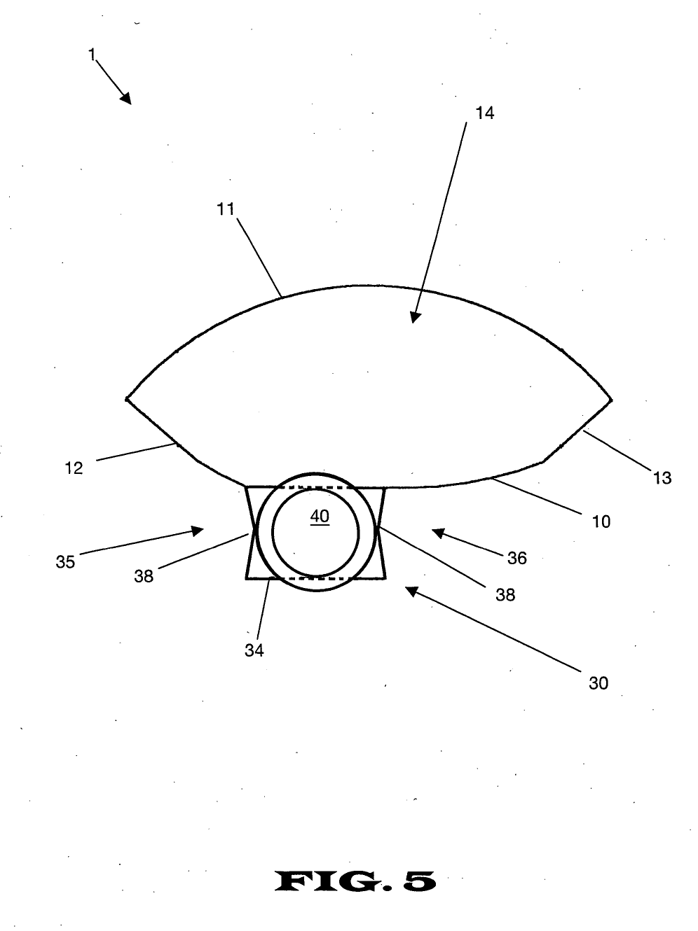

FIG. 6 is a schematic view of embodiments from the back.

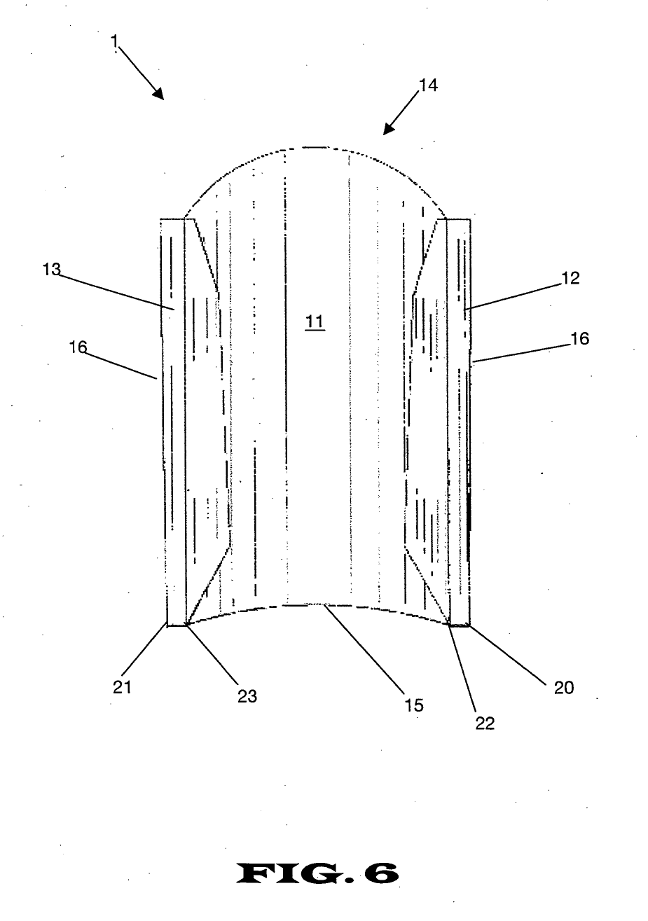

FIG. 7 is a front schematic elevational view of a sauce container according to embodiments.

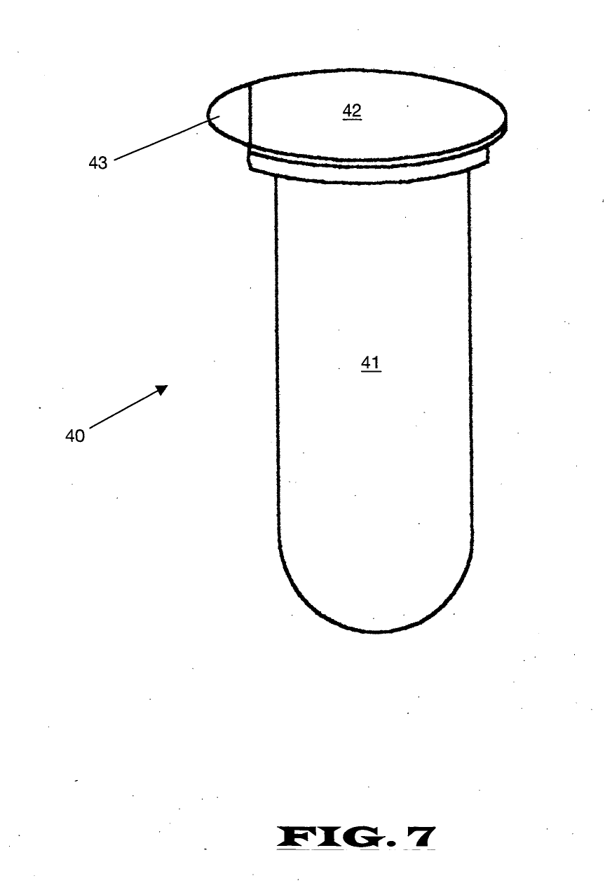

FIG. 8 is a view of the container shown in FIG. 7 from below.

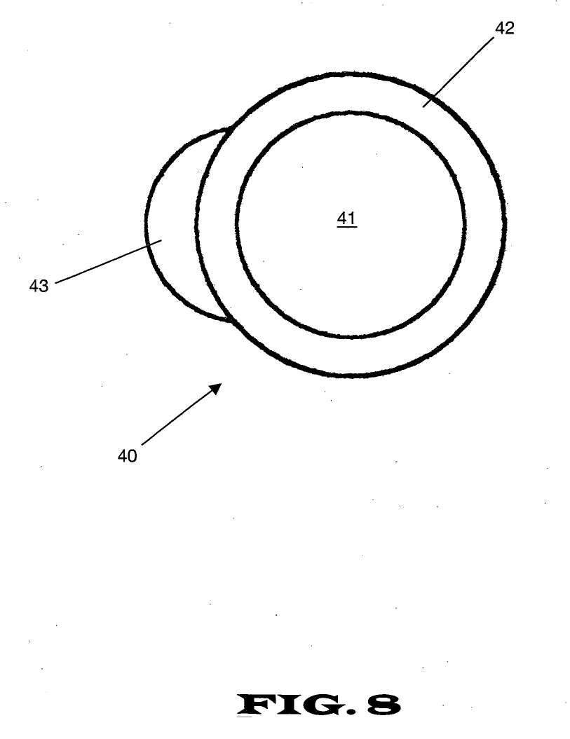

FIG. 9 is a schematic cross sectional view of embodiments with the sauce container installed from behind.

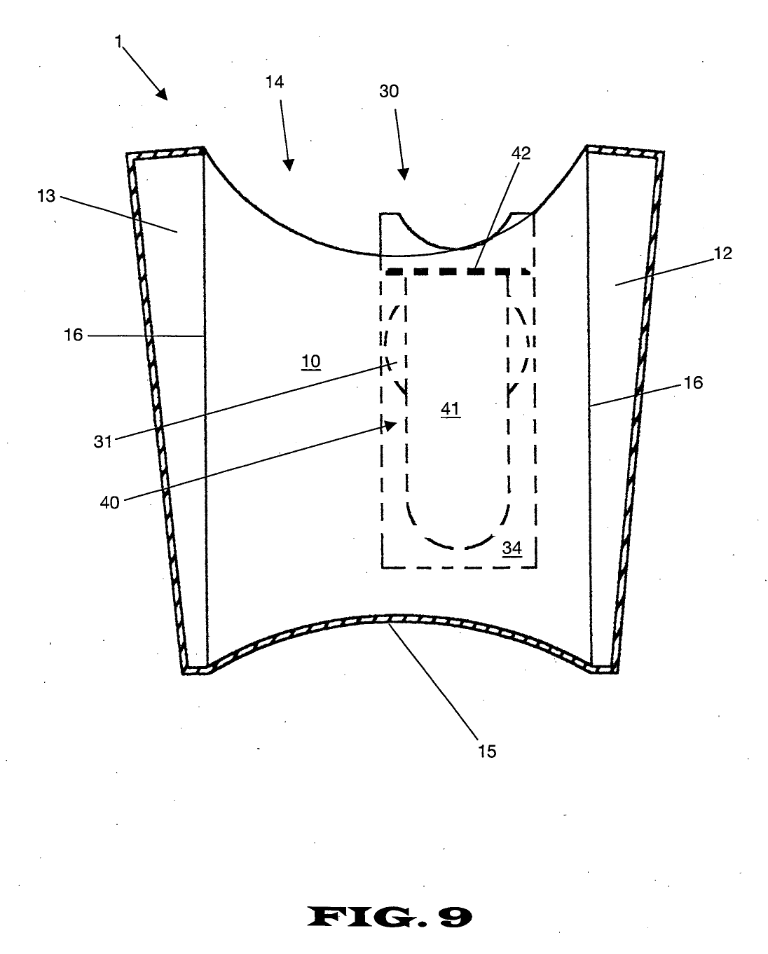

FIG. 10 is a schematic illustration of a method according to embodiments.

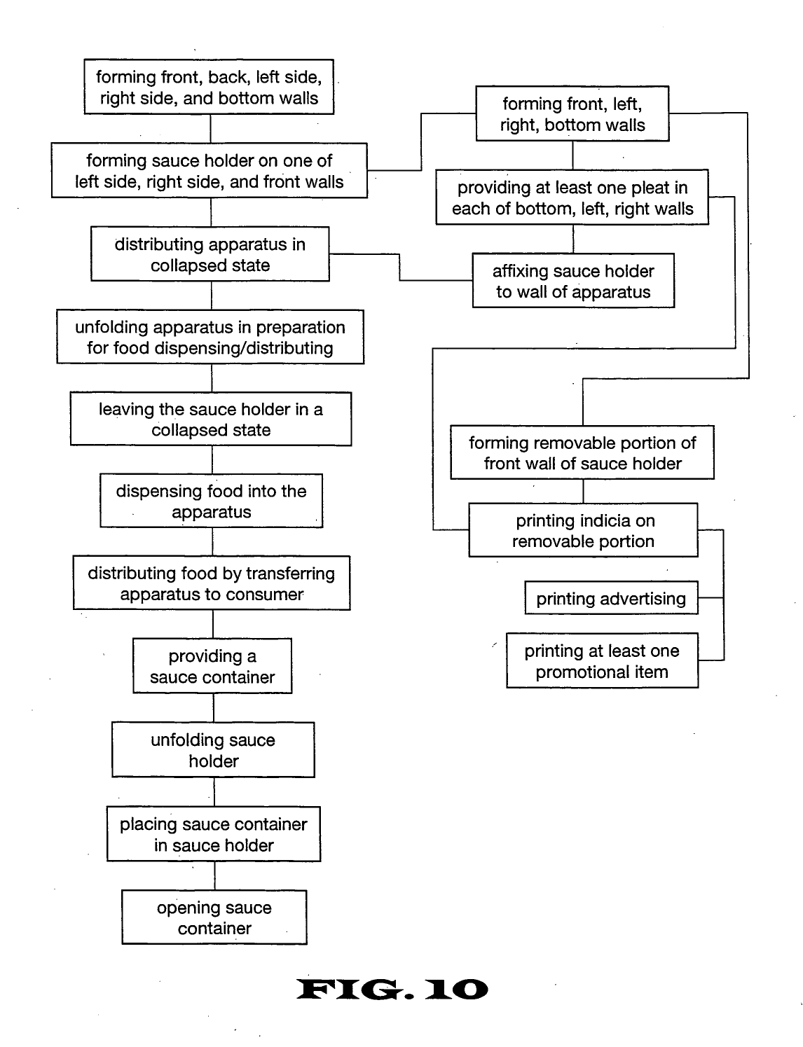

### DESCRIPTION

For convenience, at times below French fries will be used as the exemplary food distributed, and “French fry box” or “box” will be used to describe the apparatus of embodiments. It should be understood that any appropriate food, including, but not limited to, French fries, onion rings, chicken nuggets and the like, and other foods typically eaten with hands rather than with utensils, can be distributed by embodiments.

With reference to the accompanying drawings, embodiments can include a food dispensing and/or distributing apparatus 1 comprising a front 10, back 11, left side 12, right side 13, top 14, and bottom 15 walls defining a cavity when the apparatus is unfolded. The top 14 is typically open to allow dispensing of and access to the food to be placed in the apparatus 1. As seen in the FIGS., the front 10 is typically lower than the back 11 to enhance access to the food. Additionally, embodiments provide for the front 10 and back 11 to be curved outwardly to enhance the capacity of the apparatus 1.

The left and right sides 12, 13 can comprise outward pleats 16 in much the same fashion as cardboard boxes used today, in part to enhance capacity and in part to facilitate stacking of the apparatus 1 in collapsed and in open form. The bottom 15 of embodiments can include an inward pleat 17 that allows collapse of the box and that enhances the arrangement of food within the apparatus 1, particularly in the case of French fries. The apparatus 1 can further include openings 18, 19 between the bottom edges 20, 21 of the left and right sides 12, 13 and the left and right edges 22, 23 of the bottom 15. The openings 18, 19 help in collapse of the apparatus.

On the front of embodiments, a sauce holder 30 can be included, preferably in a collapsed form, at least initially. The sauce holder 30 can be integrally formed as part of the front 10 of the apparatus 1 or could be formed separately and glued onto the front 10 of the box 1. In embodiments, the sauce holder 30 includes front, left, and right walls that can include pleats to ease collapse of the holder 30, with the front of the box serving as a back wall for the holder. Embodiments include a window 31 that eases opening of the holder 30 and viewing of sauce presence/level. Further, embodiments can include a removable portion 32 of the holder 30 that, when removed, forms the window 31. The removable portion 32 further can have indicia 33 printed thereon, such as advertising, logos, coupons, and the like. The holder 30 includes a front 34, left wall 35, right wall 36, and bottom wall 37. At least the left and right walls 36 in embodiments have pleats 38, though the bottom wall 37 can also have a pleat if necessary. The holder 30 preferably can accommodate sauce packets as are commonly offered by fast food restaurants. However, embodiments contemplate the use of the holder 30 with a rigid container 40 of sauce that can be placed in the holder 30. Embodiments can also include an access port 33 into the holder 30 through which a user can insert food and/or access sauce, packeted or packetless.

In embodiments, the container 40 can include a chamber 41 that can include a lid or seal 42 that can be removed to allow access to the contents of the chamber 41. The chamber 41 is preferably cylindrical, but can take any suitable form and is preferably open on one end, which end is sealed with the lid or seal 42. Further, a tab 43 can be part of the lid or seal 42 for the container, which lid or seal 42 can be a thin layer of material affixed to the end of the chamber 41. Thus, a user can grasp the tab 42 and remove the lid or seal 42 to access the sauce within the chamber 41. Alternatively, embodiments contemplate a replaceable lid 42 that remains on the container via an interference fit.

Embodiments contemplate a method of using the apparatus comprising distributing the apparatus in a collapsed state, unfolding the main compartment, and distributing food in the apparatus. Additionally, embodiments contemplate offering users sauce in containers 40, users then unfolding the sauce holder 30, inserting the container 40 into the holder 30, removing the lid or seal 42, and inserting food to use the sauce. Further, badging the apparatus with a particular restaurant logo or other indicia can be included, which logo or other indicia can be placed on the blank or other parts of the holder or box.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A food dispensing and distributing apparatus comprising:
front, back, left side, right side, and bottom walls;
a selectively collapsible cavity defined by the front, back, left side, right side, and bottom walls;
a top portion through which food can be dispensed into and removed from the apparatus; and
a selectively collapsible sauce holder on one of the front, back, left side, and right side walls.

2. The apparatus of claim 1 further comprising at least one pleat in each of at least the left and right side walls allowing the walls including at least one pleat to be folded, thereby enabling collapse of the apparatus into a substantially flat article.

3. The apparatus of claim 2 further comprising at least one pleat in the bottom wall to enhance collapse of the apparatus into a substantially flat article.

4. The apparatus of claim 1 wherein the sauce holder comprises front, left, right, and bottom holder walls, the front wall of the apparatus serving as a back wall for the sauce holder.

5. The apparatus of claim 4 wherein the sauce holder is initially in a collapsed state.

6. The apparatus of claim 4 wherein the sauce holder further comprises at least one pleat in each of at least the left and right holder walls, thereby enabling collapse of the sauce holder into a collapsed state.

7. The apparatus of claim 6 wherein the sauce holder further comprises at least one pleat in the bottom holder wall, thereby enhancing collapse of the sauce holder into the collapsed state.

8. The apparatus of claim 1 wherein the sauce holder includes a perforated portion the front holder wall that creates a window when removed, thereby enabling visual access to at least a portion of an interior of the sauce holder.

9. The apparatus of claim 1 wherein the sauce holder selectively receives a sauce container.

10. The apparatus of claim 9 wherein the sauce container comprises a sauce chamber defined by at least one wall and a bottom, a top of the sauce chamber being open.

11. The apparatus of claim 10 wherein the open top is sealed with a sheet of material affixed thereto.

12. The apparatus of claim 11 wherein the sheet of material comprises a tab projection beyond the at least one wall of the chamber, thereby facilitating removal of the sheet of material from the open end of the chamber.

13. The apparatus of claim 10 wherein the chamber is a substantially cylindrical chamber defined by one wall and a bottom.

14. The apparatus of claim 9 wherein the sauce container is plastic.

15. The apparatus of claim 1 wherein the apparatus and the sauce holder are made from paperboard.

16. A method of using a food dispensing and distribution apparatus comprising:
forming front, back, left side, right side, and bottom walls of the apparatus;
forming a sauce holder on one of the left side, right side, and bottom walls; and
distributing the apparatus in a collapsed state.

17. The method of claim 16 further comprising:
unfolding the apparatus in preparation for food dispensing and distributing, leaving the sauce holder in a collapsed state;
dispensing food into the apparatus; and
distributing the food by transferring the apparatus to a consumer.

18. The method of claim 16 further comprising:
providing a sauce container;
unfolding the sauce holder; and
placing the sauce container in the sauce holder.

19. The method of claim 18 further comprising opening the sauce container.

20. The method of claim 16 further comprising forming a removable portion of a front wall of the sauce holder.

21. The method of claim 20 wherein forming a removable portion includes printing indicia on the removable portion.

22. The method of claim 21 wherein printing indicia comprises printing advertising.

23. The method of claim 21 wherein printing indicia comprises printing at least one promotional item.

24. The method of claim 2 wherein forming the sauce holder comprises forming front, left, and right walls.

25. The method of claim 24 wherein forming the sauce holder further comprises providing at least on pleat in each of the front, left, and right walls.

26. The method of claim 24 wherein forming the sauce holder further comprises affixing the sauce holder to a wall of the apparatus.
